(19) United States
(12) Patent Application Publication
(10) Pub. No.: US 2022/0298848 A1
(43) Pub. Date: Sep. 22, 2022

(54) ROLLER DOOR

(71) Applicant: Seuster KG, Lüdenscheid (DE)

(72) Inventor: Jörg FISCHER, Dortmund (DE)

(21) Appl. No.: 17/642,183

(22) PCT Filed: May 26, 2020
(86) PCT No.: PCT/EP2020/064500

§ 371 Date: Mar. 10, 2022

(30) Foreign Application Priority Data
Sep. 19, 2019 (DE) 10 2019 125 204.0

(51) Int. Cl. E06B 9/13; E06B 9/58; E06B 9/17

(52) U.S. Cl. CPC E06B 9/13; E06B 9/58; E06B 9/17076; E05Y 2900/132

(57) ABSTRACT

The invention relates to a roller door comprising a door leaf which is movable between an open position, in which it uncovers a wall opening at least partially and preferably forms a multi-layer coil at least partially above the wall opening, and a closed position, in which it closes the wall opening at least partially, said door leaf having a plurality of door leaf segments arranged one behind the other in the direction of movement of the door leaf. At least one stabilizing device extending perpendicular to the direction of movement of the door leaf is arranged between two door leaf segments, and the mutually facing edge regions of the door leaf segments are held on the stabilizing device, at least one edge region of at least one segment being held in a floating manner on the stabilizing device in such a way that a relative movement of this edge region with respect to the stabilizing device is possible at least in the direction of movement of the door leaf.

### CROSS REFERENCE TO RELATED APPLICATION

The present application is a 35 U.S.C. § 371 national phase entry application of, and claims priority to, International Patent Application No. PCT/EP2020/064500, filed May 26, 2020, which claims priority to German Patent Application No. DE 10 2019 125 204.0, filed Sep. 19, 2019, the disclosures of which are hereby incorporated by reference in their entirety for all purposes.

### BACKGROUND

The invention relates to a roller door comprising a door leaf which is movable between an open position, in which it uncovers a wall opening at least partially and preferably forms a multi-layer coil at least partially above the wall opening, and a closed position, in which it closes the wall opening at least partially, said door leaf having a plurality of door leaf segments arranged one behind the other in the direction of movement of the door leaf, wherein at least one stabilizing device extending perpendicular to the direction of movement of the door leaf is arranged between two door leaf segments, and the mutually facing edge regions of the door leaf segments are held on the stabilizing device.

Such roller doors are used, among other things, as so-called high-speed doors for closing industrial halls. On the one hand, it is important that the door leaf movement is safely guided. On the other hand, it is important to consider that there is often only little space available to accommodate the door leaf in the open position. To this end, for example, roller doors of the type specified and described in WO 2018/219512 A1 are provided with joint assemblies, which, for guiding the door leaf movement, are positioned in the region of the edges of the door leaf, which in the closed position extend, at least partially, in the direction of gravity, and which are fastened to the door leaf, each of the joint assemblies having a plurality of joint members, which are hingedly interconnected relative to joint axes, which extend perpendicularly to the lateral edges and approximately parallel to the door leaf plane. According to the cited document, the space requirement of the door in the open position is reduced in that at least some of the segments of the door leaf are formed from a flexible material that adapts itself to the coil to be formed in the open position and thus enables a smaller spiral diameter in the open position. By guiding the door leaf with the joint members of the joint assembly coupled to the stabilizing device, pulling or pushing forces are transmitted via the joint assembly, so that, even at high door travel speeds, reliable guidance of the door leaf movement is possible, if care is taken that the stabilizing devices of the door leaf are securely coupled to the joint members of the joint assemblies. When operating the doors known from WO 2018/219512 at high door travel speeds, however, it has been assessed that the door leaf is damaged in the region of the transitions between the stabilizing device and the door leaf segments.

In view of these problems of the prior art, the object of the invention is to provide roller doors with which a high door travel speed is possible while reducing the risk of damaging the door leaf.

According to the invention, this object is achieved by a further development of the known roller doors, which is essentially characterized in that at least one edge region of at least one segment is held in a floating manner on the stabilizing device in such a way that a relative movement of this edge region with respect to the stabilizing device is possible at least in the direction of movement of the door leaf.

The invention is based on the realization that even with the kinematics described above, in which the pushing and pulling forces are transmitted via the framework formed by the joint assemblies and the stabilizing devices, there are still considerable forces in the region of the transition between the stabilizing devices and the edge regions of the door leaf segments. These forces occur in particular during the transition to the open position and the deviation of the door leaf movement to obtain a multi-layer coil, with particularly high forces being observed when the door leaf segments are at least partially formed from a flexible material, as suggested by WO 2018/219512. In the doors proposed in this document, the door leaf segments are clamped in the stabilizing devices, possibly using a glass strip. However, the door leaf segments may slip in relation to the stabilizing device, despite the clamping function, and do not return to the original state, because this is prevented by the clamping function of the glass strip. This means that visible waves or distortions of the door leaf are formed in the region of the transition between the stabilizing device and the door leaf segment.

Attempts have been made to eliminate this drawback by fixing the door leaf segments, possibly made of flexible material, with respect to the stabilizing devices via a terminal strip in such a way that pulling out under dynamic load is just as impossible as under the action of a static force. However, it has been shown that the clamping points of the fixing strip transfer to the door leaf segments in such a way that there is also a visual impairment. In this case too, warping or similar damage occurs in the region of the transition between the stabilizing device and the door leaf segment.

In the context of the invention, it was recognized that these drawbacks can be prevented by a floating mounting of the door leaf segments with respect to the stabilizing device without impairing the overall stability of the arrangement.

In the context of this invention, use is made of the fact that stabilizing devices and possibly existing joint assemblies form a stable framework via which the forces arising during the door leaf movement can be transmitted without requiring a rigid attachment of the door leaf segments to the stabilizing devices to stabilize the overall arrangement. Therefore, a floating mounting, which enables a relative movement of the edge regions of the door leaf elements with respect to the stabilizing device, can be implemented without adversely affecting the door leaf movement or the stability of the entire door construction. On the other hand, the floating mounting allows the compensation of any play that may arise during the door leaf movement or of relative movements between the stabilizing device and the door leaf segment without damage or visual impairment to the door leaf structure due to excessive force.

The floating mounting can not only enable a relative movement between the edge region of the door leaf segment and the stabilizing device in the direction of movement of the door leaf, but also, if necessary, in a direction parallel to the floating edge region or perpendicular to the direction of movement of the door leaf, so that even with corresponding slight deviations of the door leaf movement from the specified path hardly any damage to the door leaf segments occurs.

To avoid detachment of the door leaf segments from the stabilizing devices, it has proven to be useful if the relative movement of the floating edge region of at least one door leaf segment with respect to the stabilizing device is limited by a constraining arrangement, wherein the constraining arrangement becomes effective in particular in case of a relative movement parallel to the direction of movement of the door leaf.

In a particularly preferred embodiment of the invention, the constraining arrangement comprises a widening of the floating edge region in a thickness direction perpendicular to the door leaf plane spanned by the direction of movement of the door leaf and the stabilizing device, and a receptacle formed in the stabilizing device for the widening of the edge region floatingly held thereon, wherein the receptacle has a mouth penetrated by a transition region of the segment between the widening and a region of the segment which lies exposed outside the stabilizing device, the width of which in the thickness direction is greater than the thickness of the transition region in the thickness direction, but less than the dimensions of the widening in the direction of the thickness.

In this embodiment of the invention, the stabilizing device is advantageously designed in accordance with WO 2018/219512 A1 by means of a stabilizing profile with a receiving region for receiving the widening of the edge region of the door leaf segment, wherein the receptacle of the stabilizing profile is coordinated with the dimensions of the door leaf segment such that the door leaf segment is held with play and without a clamping effect on the stabilizing profile. By adapting the dimensions of the widening to the mouth of the receptacle it can be ensured that the edge region of the door leaf segment cannot be pulled out of the receptacle in a direction which is parallel to the direction of movement of the door leaf.

A further limitation of the relative movement of the edge region of the door leaf segment with respect to the stabilizing device or the stabilizing profile can be achieved if the receptacle is delimited by a bottom on its side opposite the mouth, the distance between the mouth of the receptacle and the bottom in the direction of movement of the door leaf being greater than the length of the widening of the floating edge region in the direction of movement of the door leaf. The possible play of the floating mount of the edge region with respect to the stabilizing profile is determined by the difference in dimensions.

In a particularly preferred embodiment of the invention, the door leaf segment is formed by a web-shaped material, wherein the widening of the door leaf segment can be formed by bending the floating edge region with respect to a bending axis which is parallel to the stabilizing device. In this embodiment of the invention, no additional component is required to form the widening of the door leaf segment. The door leaf segment can be bent in the edge region running perpendicular to the direction of movement, for example by means of a roll forming process. In this case, the edge region of the door leaf segment can be bent back onto itself, for example in the manner of a hook, in order to obtain a widening of the floatingly held edge region in the direction of the thickness.

In another embodiment of the invention, the widening can be formed by a thickening of the edge region, in particular by gluing and/or welding of a beading. Both the widening of the door leaf segment formed by bending over the floating edge region and the widening formed by gluing and/or welding of a beading can extend over the entire width of the door leaf. But embodiments may also be envisaged, where the widening only extends over part of the entire width of the door leaf. In particular, in the previous embodiment of the invention, the widening can also be formed by individual widening elements applied to an edge of the door leaf segment, which elements are designed, for example, in the manner of clip elements. Such widening clips can be U-shaped components that can be formed from sheet metal, for example. In the region where these widening clips rest on the door leaf segment, hook-shaped projections can be provided to create a positive connection between the widening clips and the edge of the door leaf segment, which projections are made of plastic material, such as polycarbonate, for example. The hook-shaped projections can also be designed as barbs. When the widening clips are attached to the door leaf edge, the widening clips claw on the door leaf segments and prevent the door leaf segment from being pulled out of the receptacle of the stabilizing device. The widening clips can extend over the entire width of the door leaf segment. However, embodiments may also be envisaged, in which two, three or more widening clips are fixed separated from each other on an edge of the door leaf segment.

With regard to the assembly of a door according to the invention, it has proven to be particularly advantageous if the stabilizing device has at least two detachably mutually connected receiving parts which form opposing boundaries of the mouth.

In this embodiment of the invention, the edge region of the door leaf segment having the widening can initially be attached to a surface delimiting the mouth of a first receiving part in a direction perpendicular to the main surface of the door leaf segment or door leaf plane and then the second delimiting part forming a further boundary surface of the mouth may be connected, wherein a positive connection between the two receiving parts is possible. For example, the other receiving part can be clipped onto the first receiving part.

If the stabilizing device has two receptacles spaced apart from one another in the direction of movement of the door leaf for receiving the mutually facing edge regions of adjacent door leaf segments, it has proven to be particularly useful when the upper receptacle in the closed position and the corresponding mouth are delimited by two receiving parts which are detachably connected to one another. In this case, an upper edge of a door leaf segment can be inserted into the lower receptacle of the stabilizing device in a direction parallel to the stabilizing device. Then the door leaf segment can be inserted into a guiding device of the roller door and then the lower edge of the door leaf segment can be connected to an underneath stabilizing device by first placing the lower edge of the door leaf segment on a boundary surface of the first receiving part of the stabilizing device and then the second receiving part is attached to the first receiving part in a direction perpendicular to the door leaf plane, to form the receptacle for the lower edge region of the door leaf segment.

With regard to a possibly desired sealing function, it can be advantageous if a sealing material is received in at least one receptacle, preferably an upper receptacle of the stabilizing device, preferably in the region of the bottom of this receptacle. Additionally, or alternatively, the sealing material can also be provided between the widening in the edge region of a door leaf segment and the mouth of the receptacle. With this arrangement, damping can be achieved in the course of the door leaf movement if the widening strikes an edge of the mouth. In this way, a slight tension can also be achieved between the stabilizing device and the door leaf segment, which can compensate for slight tolerances. A sealing material arranged between the widening and the mouth can hold the plate tightly in position and reduce or completely prevent any possible noise generated when the door leaf segment moves with respect to the stabilizing device. A corresponding sealing material can be introduced into the receptacle of the stabilizing device or attached directly to the widening of the door leaf segment. This can be a sealing material that swells when moisture penetrates it. Since hardly any moisture can penetrate in the closed position into the lower receptacles in the region of the receptacles, no sealing material is generally required in these receptacles. As can be noted from the above explanations, the present invention is used with particular advantage in those doors in which at least one segment having a floating edge section has at least one plate which is at least partially made of a flexible and/or transparent material such as polycarbonate.

In order to improve the thermal insulation, it has proven to be particularly advantageous if at least one door leaf segment, which is provided with a floating edge region, has at least two plates, which are spaced from one another in the door leaf thickness direction and are approximately parallel to one another, each of which has at least one edge region, which is held on the stabilizing device and faces a neighboring door leaf segment, wherein at least one edge region of at least one plate is held in a floating manner on the stabilizing device in such a way that a relative movement of this edge region with respect to the stabilizing device is possible at least in the direction of movement of the door leaf. This edge region can be held on the stabilizing device in a similar way as previously described. In this context, it has proven to be particularly advantageous if at least one stabilizing device has two receptacles spaced apart in the door leaf thickness direction, for receiving an edge region of a plate of a door leaf segment.

In this embodiment of the invention, the plates of a door leaf segment are radially spaced apart in the open position. They are moved along radially spaced paths into the open position and deform accordingly differently. As a result, when the door leaf is moved into the open position, a brief collision may take place if the edge regions of the plates are identical and are received in identical receptacles in the stabilizing device. To solve this problem, a particularly preferred embodiment of the invention provides that at least one edge region of the inner (outer) plate facing (facing away from) the coil axis in the coil is held with greater play with respect to the stabilizing device than the corresponding edge region of the outer (inner) plate of the door leaf segment, facing away from (facing) the coil axis in the coil. To this end, the distance between the mouth of the receptacle for the edge region of the radially inner (outer) plate and the bottom of this receptacle in the direction of movement of the door leaf may be greater than the corresponding distance between the receptacle for the edge region of the radially outer (inner) plates. In this way, a possible difference in displacement (relative movement) can be compensated for by the different paths of the individual plates.

The described double plate arrangement creates an air cushion. The resulting chamber can be closed in the region of the edges of the plates that run parallel to the direction of movement of the door leaf. For this purpose, a filler material can be provided in the region of at least one of the edges parallel to the direction of movement of the door leaf, preferably between facing boundary surfaces of the plates, which, in a preferred embodiment of the invention, may be composed of a flexible material, such as an elastic rung. Elastic pads, such as foam, which are glued in or mechanically fixed, can be used as filler material. Thus, the filler material also ensures the necessary mobility when moving the door leaf into the open position and out of the open position. Additionally or alternatively, fan-like plastic elements, which are connected to one another in a hinge-like manner and can be clipped onto a plate, can also be used as a filler material.

In the context of the invention, the use of elastic pads or elastic fan elements in door leaf segments with only one plate is also envisaged, in order to compensate for the offset between the plate and the reinforcement profile in the edge region.

In this way, a sealing with respect to the lateral part of the door may be achieved. Since the door leaf segments of a door according to the invention are usually at least partially transparent, it is particularly preferred, within the scope of the invention, if the filler material extends over 50% or less, in particular 20% or less, of the door leaf width in a direction parallel to the stabilizing devices, so that the transparency of the door leaf segments is only slightly affected.

Regarding the desired thermal separation between the inside of the door leaf (inside space) and the outside of the door leaf (outside space), it has proven to be particularly useful if at least one stabilizing device has at least two stabilizing elements which are spaced apart in the direction of the thickness of the door and which are connected to one another via a connecting element made of thermally insulating material. When using stabilizing elements with sufficient strength, such as stabilizing elements made of steel or aluminum, a satisfactory stabilizing effect can be achieved without impairing the thermal separation.

In order to provide a door that enables high door travel speeds, joint assemblies for guiding the door leaf movement are preferably provided, which are positioned in the region of the lateral edges of the door leaf, which run at least in sections in the direction of gravity in the closed position, and are attached to the door leaf, which assemblies may interact with corresponding fixed guide devices such as guide rails, wherein each of the joint assemblies has a plurality of joint members, which are hingedly connected with respect to joint axes, which are perpendicular to the direction of movement or the lateral edges of the door leaf, so that the door leaf is connected to the joint assemblies via the stabilizing devices. In this respect, the structure of the doors according to the invention corresponds to the structure of the doors described in WO 2018/219512 A1, for example. The disclosure content of this document with regard to the design of the joint assemblies and the guide rail as well as the coupling of the stabilizing devices to the joint assemblies is incorporated into this description by explicit reference to the same.

As in the known doors, also in the roller doors according to the invention at least one segment of flexible material can be arranged between two stabilizing devices, wherein a lateral edge of the segment, which is approximately perpendicular to the stabilizing devices and the joint axes and which is approximately parallel to the joint assemblies and the direction of movement of the door leaf, can extend over two, three or more joint members and at least one edge region of the segment can be held in a floating manner on a stabilizing device.

According to WO 2018/219512 A1, at least one stabilizing device can extend approximately parallel to a joint axis and be connected along this joint axis with at least two, preferably with at least two joint assemblies provided on opposite lateral door leaf edges. In order to increase the overall stability of the arrangement, at least one reinforcement strip, which extends approximately parallel to the lateral edge of the door leaf or the direction of movement of the door leaf and is fastened to the door leaf, can be provided. Similar to doors according to WO 2018/219512 A1, at least one possibly oval-spiral-shaped guide track for guiding the door leaf movement and for defining the open position of the door leaf can be provided, wherein at least one joint member may have a guide arrangement on its side facing away from the door leaf, for guiding the door leaf movement, which cooperates with the guide track and which preferably comprises at least one guide roller rotatably held with respect to a roller axis running parallel to the joint axes, which is preferably received in a guide track, at least in the open position of the door leaf.

In order to obtain a simple adaptation of the structure of the door leaf of a roller door according to the invention, it has proven to be particularly advantageous if a stabilizing device extending parallel to a joint axis is connected only to the joint assemblies. This embodiment of the invention allows a variable stabilization of the door leaf while keeping the same design of the individual door leaf segments or plates, if the stabilizing device connected only to the joint assemblies can be attached to the joint assemblies regardless of the dimensions of the individual door leaf segments. The stabilizing device is not attached to the door leaf segments or plates. The attachment of this additional stabilizing device therefore does not require any adaptation of the geometry of the door leaf segments or plates. The variability of the attachment of this stabilizing device is limited only by the pitch of the joint members of the joint assembly.

If additional collision protection is to be provided for roller doors according to the invention, the stabilizing device connected only to the joint assemblies can be positioned between lower stabilizing devices connected to the plates of the roller door. In the context of the invention, however, it has proven to be particularly advantageous if the stabilizing device that is not connected to the door leaf segments is arranged between the two upper stabilizing devices that are connected to the segments. In this way, a sealing adapted to the height of the wall opening can be achieved in the lintel region of the wall opening without having to change the geometry of the door leaf segments and of the other components of the roller door according to the invention.

In this context, it has proven to be particularly advantageous if the stabilizing device connected only to the joint assemblies but not to the door leaf segments has a sealing arrangement on its side facing away from the adjacent door leaf segment that can be placed against a lintel of the wall opening and/or if it is provided on its side facing the segment with at least one sealing strip which extends approximately parallel to the joint axes, preferably over substantially the entire width of the door and which can be placed against the adjacent segment.

According to a particularly preferred embodiment of the invention, the leading edge of the door leaf during an opening movement can be formed by a leading stabilizing device that is non-rotatably connected to an upper edge of a segment made of a flexible material in the closed position and which is rotatably connected to a guide arrangement. This arrangement prevents undesired bulging out of the door leaf segment, as is explained in detail in WO 2018/219512.

To obtain a tight guide closure, it has proven to be advantageous if a sealing arrangement is associated with at least one joint member of a joint assembly, wherein, in the closed position, the sealing arrangement can be placed on a boundary surface, in particular the inner boundary surface, of the door leaf, as explained in detail in WO 2018/219512. Furthermore, within the scope of this invention it is envisaged that, during an opening movement, a biasing device, which can be coupled to a trailing edge of the door leaf and which is pretensioned in the course of the opening movement, may be provided for braking the opening movement and for providing a biasing force, which urges the door leaf from the open position into the closed position.

As can be seen from the above explanation, a door according to the invention advantageously has a guide device for guiding the door leaf movement between the open position and the closed position. The invention is used with particular advantage in doors that allow a high door travel speed. For this purpose, the guide device can enable contactless magnetic guidance. For this purpose, the guide device can have a door leaf-side magnetic field generating device and a magnetic field generating device fixed with respect to the wall opening, the magnetic field generating devices being designed to obtain a contactless guidance of the door leaf movement along at least one section of the predetermined path in the region of at least one of the opposing lateral edges.

Corresponding guide arrangements are described in PCT/EP2019/058221.

The disclosure content of this document with regard to the guide devices and the magnetic field generating arrangements is hereby incorporated into this description by explicit reference to the same. In this context, it is of particular importance that the guide arrangement has at least one guide rib, which is fixedly arranged with respect to the wall opening and extends along a section of the predetermined path, with two outer boundary surfaces and wherein at least two guide devices are attached to the door leaf, wherein a first outer boundary surface of the guide rib forms a guide surface for a first guide device and a second outer boundary surface of the guide rib forms a second guide surface for a guide device, so that the guide rib is received between the guide devices attached to the door leaf. As an alternative or in addition to the magnetic field generating devices, at least one guide device can have a guide roller rotatably held with respect to a roller axis which is perpendicular to the predetermined path and which, in the closed position, is approximately parallel to the door leaf, which guide roller rolls on a guide surface of the door leaf when the door leaf moves.

If a contact-free guidance of the door leaf movement by means of magnetic fields generating devices is used, at least one magnetic field generating device, preferably at least one door leaf-side magnetic field generating device, can have at least one permanent magnet. Advantageously, the door leaf-side magnetic field generating device can have two permanent magnets, which are arranged on opposite sides of the guide rib, and which are fixed to a common support, which overlaps a door leaf-side edge of the guide rib. Further details of the magnetic field generating devices are described in PCT/EP2019/058221, the disclosure content of which with regard to the magnetic field generating devices is also incorporated in this description by explicit reference.

According to a further aspect, the invention relates to a method for manufacturing a segment plate for a roller door according to the invention, which is essentially characterized in that a plastic web, preferably at least partially made of polycarbonate, is continuously drawn in a conveying direction from an unwinding reel, i.e. a roll or coil, at least one edge of the plastic web running parallel to the conveying direction is bent over, if necessary by means of a coil former, and then a plate is separated along a cutting line, which is approximately perpendicular to the conveying direction, from the plastic web. In this way, the plates for roller doors according to the invention can be produced in a continuous production process. The roll former can be a double-head profiling system, for example. The plastic sheet can be delivered wound in a spiral shape on the unwinding reel and fed into the manufacturing process. In comparison to the processing of polycarbonate materials in the form of sheets, this enables fast and, at the same time, precise production of the individual plates for a roller door according to the invention in a continuous production process.

### BRIEF DESCRIPTION OF THE DRAWINGS

The invention is explained in the following with reference to the drawing, to which explicit reference is made with regard to any details essential to the invention which not detailed in the description. In the drawing, in particular:

FIG. 1 shows a schematic representation of a lateral edge region of a roller door according to the invention,

FIG. 2 shows a detailed representation of the transition, denoted by A in FIG. 1, between door leaf segments and a stabilizing device,

FIG. 3 shows a detailed illustration corresponding to FIG. 2 according to a further embodiment of the invention,

FIG. 4 is a schematic representation of a lateral edge region of an inventive roller door according to a second embodiment of the invention,

FIG. 5 shows a schematic representation of a roller door according to the invention according to a third embodiment of the invention,

FIG. 6 shows a schematic representation of a roller door according to the invention according to a fourth embodiment of the invention,

FIG. 7 shows a schematic representation of a roller door according to the invention according to a fifth embodiment of the invention and

FIG. 8 shows a schematic representation of a production plant for the plates of a roller door according to the invention.

### DETAILED DESCRIPTION

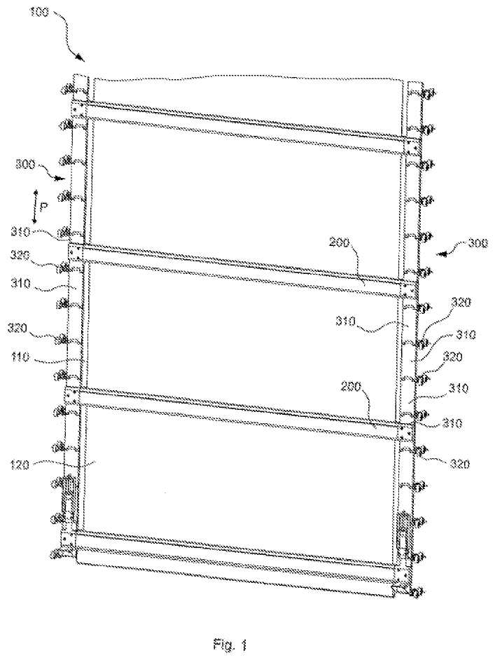

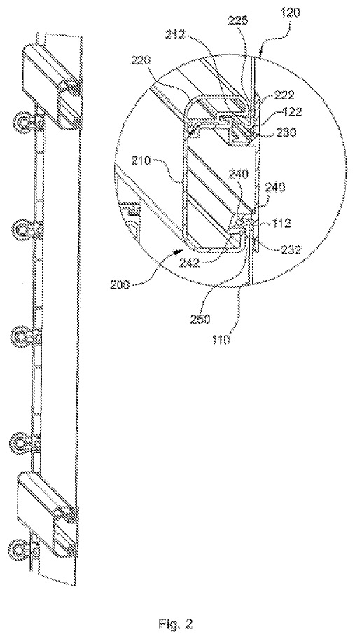

FIG. 1 shows two door leaf segments 110 and 120 of a door leaf 100 of a door according to the invention arranged one behind the other in the direction of movement of the door leaf indicated by the double arrow P. A stabilizing device designed as a stabilizing profile 200 is arranged between the door leaf segments 110 and 120. The stabilizing profile 200 extends in a direction perpendicular to the direction of movement of the door leaf P approximately in the door leaf plane. A bottom edge of the top door leaf segment 120 is floatingly held in the region of an upper receptacle 230 (see FIG. 2) of the stabilizing profile 200, while an upper edge of the lower door leaf segment 110 is floatingly held in a lower receptacle 240 (see FIG. 2) the stabilizing profile 200 is kept floating. An upper edge of the door leaf segment 120 is held on a further stabilizing profile 200, in the same way as a lower edge of the door leaf segment 110 is also held on a lower stabilizing profile 200.

The stabilizing profiles 200 are attached to a joint assembly 300 which extends approximately parallel to the direction of movement of the door leaf or which extends parallel to a lateral edge of the door leaf 100. The joint assembly 300 comprises a plurality of joint members 310, which are arranged one behind the other in the direction of movement of the door leaf and which are hingedly interconnected with respect to joint axes, which are perpendicular to the direction of movement P of the door leaf. In particular, three joint members 310 are arranged between two adjacent stabilizing profiles 200. In other embodiments of the invention, only one or two or four or more joint members can be provided between the stabilizing profiles 200. A stabilizing profile can also be provided in the region of each connection between successive joint members.

On its side facing away from the door leaf segments 110 and 120, the joint assembly has guide rollers 320 which are rotatably held with respect to roller axes extending parallel to the joint axes. The guide rollers 320 are respectively arranged in pairs in the region of a joint axis in such a way that they can accommodate a guide rib between them and can roll over opposing boundary surfaces of the guide rib, in order to guide the door leaf movement, as described in PCT/EP2019/058221.

As can be seen particularly clearly in FIG. 2, an upper edge region 112 of the door leaf segment 110 extending parallel to the joint axes and parallel to the stabilizing profile 200 is arranged in a receptacle 240 of the stabilizing profile 200. The upper edge 112 of the door leaf segment 110 is formed, by bending over of the upper edge of the door leaf segment 112, as a widening in a plane extending perpendicularly to the door leaf plane determined by the direction of movement of the door leaf P and the stabilizing profile 200. Starting from the widening 112, the door leaf segment 110 extends downward with a transition region through an opening 250 of the stabilizing profile 200 and is exposed outside the opening 250, as can be seen in FIG. 1. Likewise, the door leaf segment 120 has a widening 122, which is received in a receptacle 230 of the stabilizing profile 200. Starting from the widening 122, the door leaf segment 120 extends upwards with a transition region through an opening 225 and is exposed outside the opening 225.

The mouth 250 is delimited by boundary surfaces 232 and 242, which are separated from one another by a distance in a direction parallel to the door leaf thickness, which is less than the thickness of the widening 112, but greater than the thickness of the transition region of the door leaf segment 110 between the widening 112 and the region exposed outside the stabilization profile 200. The mouth 225 is also delimited by boundary surfaces 212 and 222, the distance between which in the door leaf thickness direction is less than the thickness of the widening 122, but greater than the thickness of a transition region between the widening 122 and the region of the door leaf segment 120 exposed outside the stabilizing profile 200.

As can also be seen in FIG. 2, the stabilizing profile 200 is composed of two parts 210 and 220 that are detachably connected to one another. The recess 240 on the lower edge of the stabilizing profile 200 is entirely formed by the first stabilizing profile part 210, while the receptacle 230 on the upper edge of the stabilizing profile 200 is formed by the two stabilizing profile parts 210 and 220. A first boundary surface 212 of the mouth 225 is formed by the first stabilizing profile part 210, while a second boundary surface 222 of the receptacle 230 is formed by the second stabilizing profile part 220.

In order to assemble a roller door of the type shown in the drawing, an upper edge of a door leaf segment can be pushed into the receptacle 240 in a direction parallel to the stabilizing profile 200, wherein a transition region between the widening 240 and a region of the door leaf segment that lies exposed outside the stabilizing profile 200 passes through the mouth 250. The module prepared in this way can be threaded into a guide device, which can consist of a guide rib arranged between the guide rollers 320. Subsequently, a lower edge 122 of the door leaf segment can be placed on a boundary surface 212 of the first stabilizing profile part 210 and the second stabilizing profile 220 can be clipped onto the first stabilizing profile 210, in order to form the opening 225, which is passed through by the transition region between a widening of the door leaf segment, which is received in the receptacle 230 and a region of the door leaf segment that lies exposed outside the stabilizing profile 200.

The distance between the mutually opposite boundary surfaces 212 and 222 or 232 and 242 of the mouths 225 and 250 is greater than the thickness of the transition regions passing through these mouths. This prevents a clamping effect in the region of the transition regions.

Furthermore, the distance between the mouths 225 and 250 and the bottoms of the receptacles 230 and 240, which are opposite to the corresponding mouths 225 and 250 is greater than the length of the widenings 122 and 112 in the direction of movement of the door leaf. This enables a relative movement of the door leaf segments 110 and 120 with respect to the stabilizing profile 200.

In the region of the bottom of the receptacle 230, a sealing material can be arranged, which, if necessary, swells when moisture penetrates.

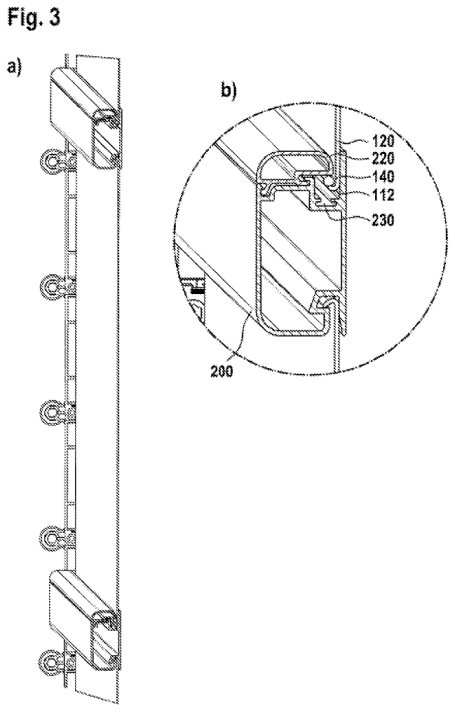

The embodiment of the invention shown in FIG. 3 differs essentially from the embodiment explained with reference to FIG. 2 in that between the bent over lower edge of plate 120 forming the widening 122 and the lower boundary surface of part 220 of stabilizing profile 200 a damping element 230 is arranged, which on the one hand provides a sealing of the floating plate 120 held in the stabilizing profile 200, and on the other hand causes a biasing of the floating plate 120 held in the stabilizing profile 200, which helps to compensate for tolerances and holds the plate 120 tightly in its position. Furthermore, the damping element 140 reduces noise, which can occur when the bent over lower edge of the plate 120 is moved in the receptacle 230 and hits against the lower boundary surface of the part 220 of the stabilizing profile.

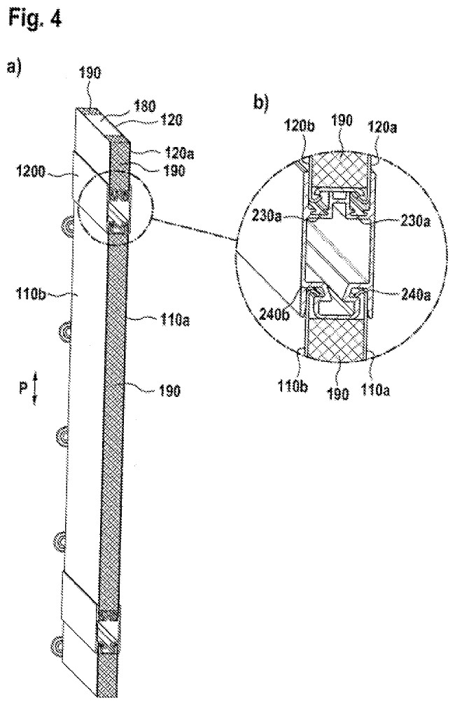

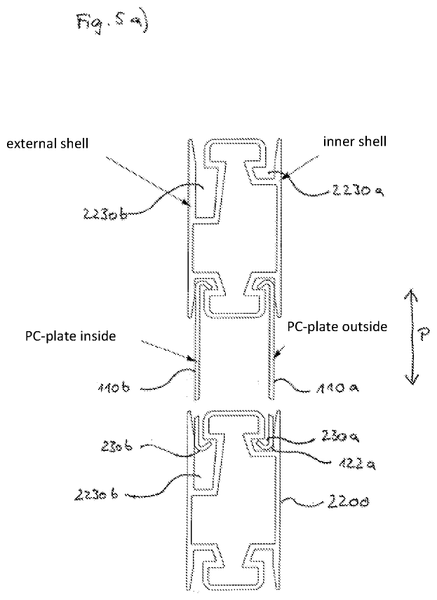

The embodiment of the invention shown in FIG. 4 differs essentially from the embodiment of the invention shown with reference to FIGS. 1 and 2, in that the door leaf segments are provided with two generally mutually parallel plates 120a and 120b, or 110a and 110b, which are designed as flexible polycarbonate plates. The lower edges of the plates 120a and 120b are each provided with a widening formed by bending over these edges, which are floatingly held in receptacles 230a and 230b of the stabilizing profile 1200. The upper edges of the plates 110a and 110b of the lower segment are held in receptacles 240a and 240b of the stabilizing profile 1200. An air cushion 180 for thermal insulation is formed between the plates 120a and 120b or 110a and 110b. The air cushion 180 is closed at the edges running parallel to the direction of movement P of the segments 120 and 110 by elastic pads 190 provided between the plates 120a and 120b or 110a and 110b. These pads 190 can be provided by elastic rungs. For example, elastic pads made of a foam-like material can be used, which are glued in or mechanically fixed. The elastic design of the pads 190 also enables the necessary mobility when winding the door leaf in the spiral guide track when the open position is reached.

Additionally or alternatively, fan-like plastic elements, which are hingedly connected to one another, can also be clipped onto the plate in the chamber 180. The use of corresponding elastic pads or elastic fan elements in door leaf segments with only one plate, as shown in FIGS. 1 and 2, can also be envisaged to compensate for the offset between the plate and the stabilizing profile in the wall region. As a result, the sealing of the door leaf in the closed position can be improved.

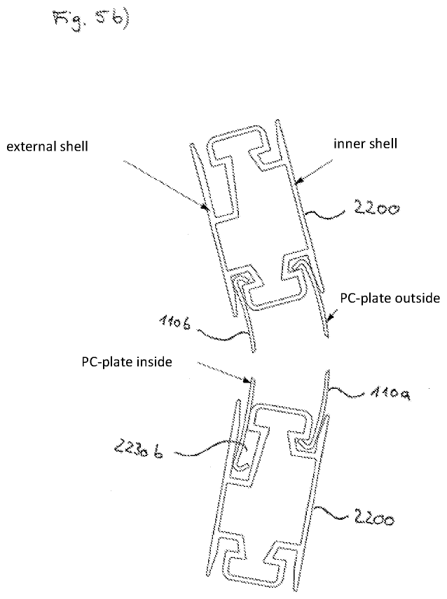

The embodiment of the invention shown in FIG. 5 differs essentially from the embodiment explained with reference to FIG. 4 in that the chamber 2230b of the stabilizing profile 2200, which is provided to accommodate the widening 230b on the lower edge of the plate 110b, has a greater depth in the direction of movement of the door leaf than the chamber 230a, which is used for receiving the widening 122a formed on the lower edge of the plate 110a. This ensures that the plate 110b, which is located radially on the inside in the open position, is held with greater play in the receptacle 230b than the plate 110a, which is located radially on the outside in the open position. As a result, when the door leaf reaches the open position, the different deformation of the plates 110a and 110b can be compensated for, as illustrated in FIG. 5b).

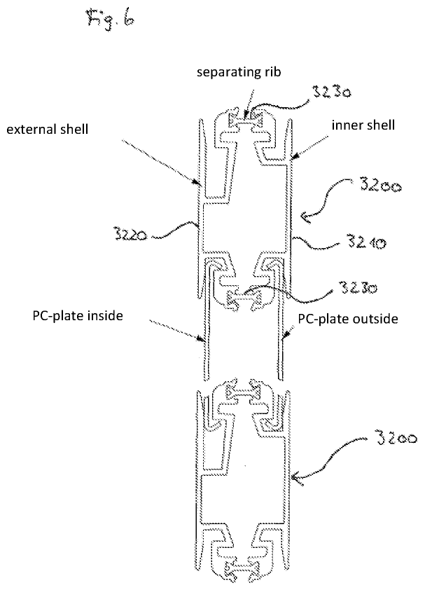

The embodiment of the invention shown in FIG. 6 differs essentially from the embodiment of the invention explained with reference to FIG. 5 in that the stabilizing profiles 3200 are generally composed of three parts, wherein the parts 3210, 3220, 3230 are provided in sequential order in the door leaf thickness direction.

The part 3210 that is on the inside in the closed position of the door leaf, like the part 3220 of the stabilizing profile 3200 that is on the outside in the closed position, is made of a metallic material. This gives the stabilizing profile the necessary stability. The parts 3210 and 3220 are connected to one another via connecting elements 3230 made of thermally insulating material such as plastic. Thus, while ensuring adequate overall stability of the stabilizing profiles 3200, heat loss between the inner space and the external space can be effectively reduced via the stabilizing profiles 3200.

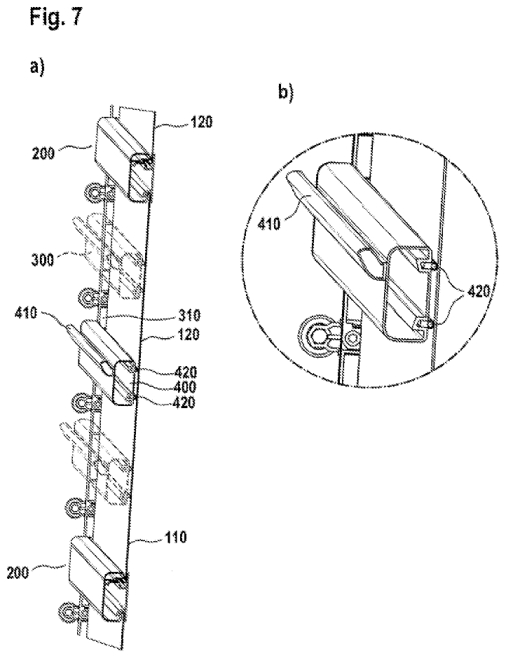

The embodiment of the invention shown in FIG. 7 differs essentially from the embodiment of the invention shown with reference to FIGS. 1 and 2 in that, between the stabilizing profiles 200, which are fixed at the lower and upper edges of plates 110, 120 a stabilizing profile 400 is provided, which is attached exclusively to the joint members of the joint assembly 300. This additional stabilizing profile 400 can be positioned independently of the plate geometry and can be attached to position a lintel seal depending on the height of the wall opening. For this purpose, the stabilizing profile 400 is equipped with a sealing element 410 on its side facing away from the plates 110, 120, while on the side facing the plate 120 it is provided with hose seals 420 that rest against the plate 120. Since the additional stabilizing profile 400 is not attached to the plates 120, it can be attached to any joint links 310 regardless of the plate geometry. The position of the seal 410 can thus be adapted to the height of the wall opening. This not only improves the sealing effect, but also increases the overall stability of the roller door.

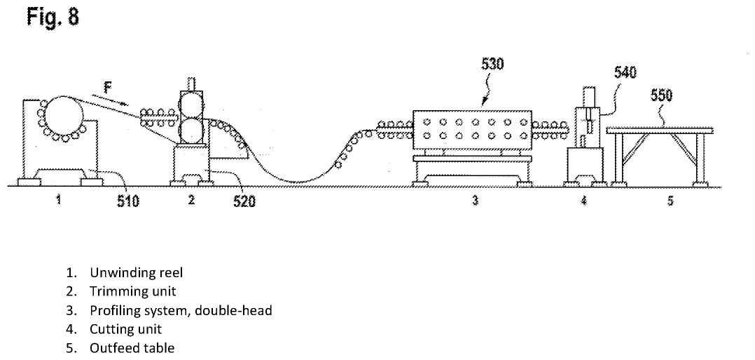

In FIG. 8 a system for the production of plates for the door leaf segments of rolling doors according to the invention is shown schematically. When using the system shown in FIG. 8, a plastic web made at least partially of polycarbonate is continuously unwound in a conveying direction F from an unwinding reel 510. The plastic web runs through a trimming unit 520, in which the exact width of the plastic web is set, and then through a double-head profiling system 530, in which the edges of the plastic web running parallel to the conveying direction F are bent over to create the widening of the plates. As can be seen in FIG. 8, the profiling system has a plurality of shaping rollers with which the edges of the material web are gradually bent over. After leaving the double-head profiling system 530, plates of a predetermined length are cut from the material web by means of a cutting unit 540 along a cutting line running perpendicular to the conveying direction F and are then placed on an outfeed table 550. The following features of methods according to the invention are of particular importance in the context of this invention. They can be essential to the invention individually or in combination with one another:
The plastic web is produced by extrusion and wound into a coil or

roll. The width of the plastic web or the coil depends on the extruder size.
The width of the extruded plastic web, such as an extruded polycarbonate web, is subject to fluctuations. With a trimming station, the material web can be trimmed to the desired width, preferably before entering the forming station.
In the trimming station, a wider plastic web can be split to a narrower size. This allows the required plate size to be determined depending on the size of the door.
A plastic web, in particular a polycarbonate web, after passing through a shaping device, possibly designed as a double-head profiling system, can have significantly higher restoring forces than steel. Therefore, when carrying out the method according to the invention, a significant overbending is preferably achieved in order to ultimately obtain the desired contour. This also takes into account the fact that the deformation can relax over time and the deformed state can transition away from the shape obtained after leaving the deformation station, under the effect of the restoring forces.
In order to reduce the restoring forces, it has proven to be useful to support the forming process with heat. When using polycarbonate webs, the webs are advantageously heated to a temperature between 150 and 170 degrees Celsius, at least in the forming region. This has the following effects:

1. There is a gentler deformation with less stress on the polycarbonate and thus cracks are prevented in the deformation region.

2. The forming stresses are neutralized and the restoring forces are minimized.
Plastics material, in particular polycarbonate, has a lower inherent stability than steel. Therefore, it has proven to be particularly advantageous within the scope of the invention if the plastic web is supported between the edges running parallel to the conveying direction, in the region of which the individual deformation stages can also be arranged. The support of the plastic web between the edges can be obtained with at least one conveyor belt. With the conveyor belt, the plastic web is supported between the edges running parallel to the conveying direction and is conveyed in the conveying direction. It has proven to be particularly useful if the plastic web is held from above and below by means of suitable conveyors in order to ensure the stability required for a continuous shaping process.
Instead of conveyor belts, other conveying devices or supporting devices suitable for supporting the plastic web can also be used.

The invention is not limited to the exemplary embodiment explained with reference to the drawing. For example, the widenings in the region of the edges of the door leaf segments can also be formed by glued or welded beadings. The stabilizing profiles 200 can generally be integrally formed, so that the widened edges of the door leaf segments have to be pushed laterally into the stabilizing profiles. Instead of a guide arrangement in which two guide rollers contact opposing boundary surfaces of a guide rib, guide arrangements can also be used, in which guide rollers are accommodated inside a guide rail. Instead of a guiding systems composed of guide rollers, a contactless magnetic guide can also be used.

1. A roller door comprising a door leaf which is movable between an open position, in which it uncovers a wall opening at least partially and preferably forms a multi-layer coil at least partially above the wall opening, and a closed position, in which it closes the wall opening at least partially, said door leaf having a plurality of door leaf segments arranged one behind the other in a direction of movement of the door leaf, wherein at least one stabilizing device extending perpendicular to the direction of movement of the door leaf is arranged between two door leaf segments, and mutually facing edge regions of the door leaf segments are held on the stabilizing device, wherein at least one edge region of at least one segment is held in a floating manner on the stabilizing device such that the edge region is relatively movable with respect to the stabilizing device at least in the direction of movement of the door leaf.

2. The roller door according to claim 1, characterized by a constraining arrangement, which limits the relative movement of the floatingly held edge region with respect to the stabilizing device.

3. The roller door according to claim 2, wherein the constraining arrangement is composed of a widening of the floatingly held edge region in a thickness direction perpendicular to the plane of the door leaf, which is defined by the direction of movement of the door leaf and the stabilizing device, and a receptacle formed in the stabilizing device for the widening of the edge region, which is held thereon in a floating manner, wherein the receptacle has a mouth, which is passed through by a transition region of the segment between the widening and a region of the segment, which lies exposed outside the stabilizing device, wherein a width of the mouth, in the thickness direction, is greater than a thickness of the transition region in the thickness direction, and less than dimensions of the widening in the thickness direction.

4. The roller door according to claim 3, wherein the receptacle is delimited on its side opposite the mouth by a bottom, wherein the distance between the mouth and the bottom in the direction of movement of the door leaf is greater than a length of the widening of the floatingly held edge region in the direction of movement of the door leaf.

5. The roller door according to claim 3, wherein at least one widening is formed by bending the floatingly held edge region with respect to a bending axis running parallel to the stabilizing device.

6. The roller door according claim 3, wherein at least one widening is formed by a thickening of the edge region, in particular by gluing and/or welding of a beading.

7. The roller door according claim 3, wherein at least one widening is formed by a widening element, such as a widening clip, held in a positive, non-positive and/or material fit on an edge region of at least one door leaf segment.

8. The roller door according to claim 1, wherein the stabilizing device has at least two detachably interconnected receiving parts which form opposing boundary surfaces of the mouth.

9. The roller door according to claim 1, wherein at least one segment having a floatingly held edge region has at least one plate which is formed at least in sections from a flexible and/or transparent material such as polycarbonate.

10. The roller door according to claim 1, characterized by joint assemblies for guiding the door leaf movement, which are positioned in the region of lateral edges of the door leaf, which extend at least in sections, in the closed position, in the direction of gravity, wherein each of the joint assemblies has a plurality of joint members, which are hingedly connected to one another with respect to joint axes, which are perpendicular to the direction of movement or the lateral edges of the door leaf, wherein the door leaf is connected with the joint assemblies by means of the stabilizing devices.

11. The roller door according claim 3, characterized by a sealing material which is preferably received between the widening and the mouth in the receptacle.

12. The roller door according claim 8, wherein the stabilizing device has two receptacles, which are spaced from one another in the direction of movement of the door leaf, wherein the upper receptacle, in the closed position, is delimited by two receiving parts detachably connected to one another.

13. The roller door according claim 9, wherein at least one door leaf segment, which is provided with the floatingly held edge region, has at least two plates, which are spaced from one another in the door leaf thickness direction and are approximately parallel to one another, each of which has at least one edge region, which is held on the stabilizing device and faces a neighboring segment, wherein at least one edge region of at least one plate is held in a floating manner on the stabilizing device such that the edge region is relatively movable with respect to the stabilizing device at least in the direction of movement of the door leaf.

14. The roller door according to claim 13, wherein at least one stabilizing device has two receptacles spaced from one another in the direction of the thickness of the door leaf, each for receiving an edge region of a plate of a door leaf segment.

15. The roller door according to claim 13, wherein at least one edge region of the inner (outer) plate facing (facing away from) the coil axis in the coil is held with greater play with respect to the stabilizing device than the corresponding edge region of the outer (inner) plate of the door leaf segment facing away from (facing) the coil axis in the coil.

16. The roller door according to claim 1, characterized by a filler material, preferably made of flexible material, arranged on at least one of the edges of at least one door leaf segment running parallel to the direction of movement of the door leaf, preferably between mutually facing boundary surfaces of the plates.

17. The roller door according to claim 16, wherein the filler material extends over 50% or less of the door leaf width in a direction parallel to the stabilizing device.

18. The roller door according to claim 1, wherein at least one stabilizing device has two stabilizing elements which are spaced apart in the direction of the thickness of the door leaf and which are connected to one another via a connecting element made of thermally insulating material.

19. The roller door according to claim 1, wherein at least one segment made of flexible material is arranged between two stabilizing devices, wherein a lateral edge of the segment, which is perpendicular to the stabilizing devices and which is approximately parallel to the joint assemblies extends over two, three or more joint members and at least one edge region of the segment is held in a floating manner on a stabilizing device.

20. The roller door according claim 10, wherein at least one stabilizing device extends approximately parallel to a joint axis and is connected along this joint axis to at least one, preferably to two joint assemblies provided on opposite lateral door leaf edges.

21. The roller door according claim 10, wherein a stabilizing device extending parallel to a joint axis is only connected to the joint assemblies.

22. The roller door according to claim 21, wherein the stabilizing device connected only to the joint assemblies has, on its side facing away from the segment, a sealing arrangement which can be placed against a lintel of the wall opening.

23. The roller door according to claim 21, wherein the stabilizing device connected only to the joint assemblies has on its side facing the segment at least one sealing strip, which extends approximately parallel to the joint axes, preferably over substantially the entire width of the door and which can be placed on the segment.

24. The roller door according to claim 1, characterized by at least one reinforcement strip which extends parallel to the lateral edge of the door leaf and is fastened to the door leaf.

25. The roller door according to claim 1, characterized by at least one possibly oval-spiral guide track for guiding the movement of the door leaf and for defining the open position of the door leaf.

26. The roller door according to claim 25, wherein at least one joint member has on its side facing away from the door leaf a guide arrangement which interacts with the guide track for guiding the door leaf movement and which preferably comprises at least one guide roller which is rotatably held with respect to a roller axis running parallel to the joint axes, which is received in a guide track preferably at least in the open position of the door leaf.

27. The roller door according to claim 1, wherein the leading edge of the door leaf, during an opening movement, is formed by a leading stabilizing device, which is rotatably connected to an upper edge of a segment made of a flexible material in the closed position and which is rotatably connected to a guide arrangement.

28. The roller door according to claim 1, wherein a sealing arrangement is associated with at least one joint member of a joint assembly, wherein, in the closed position, the sealing arrangement can be placed on a boundary surface, in particular the inner boundary surface, of the door leaf.

29. The roller door according to claim 1, characterized by a biasing device which, during an opening movement, can be coupled to a trailing edge of the door leaf and which can be pretensioned in the course of the opening movement, for braking the opening movement and for providing a biasing force, which urges the door leaf from the open position into the closed position.

30. The door according to claim 1, with a guide device for guiding the movement of the door leaf between the open position and the closed position.

31. The door according to claim 29, wherein at least one guide device has a door leaf-side magnetic field generating device and a magnetic field generating device fixed with respect to the wall opening, the magnetic field generating devices being designed to obtain a contactless guidance of the door leaf movement along at least one section of the predetermined path in the region of at least one of the opposing lateral edges.

32. A method for manufacturing a segment plate for a roller door according to claim 1, wherein a plastic web, at least partially made of polycarbonate, is continuously drawn in a conveying direction from an unwinding reel, or a roll or coil, wherein at least one edge of the plastic web running parallel to the conveying direction is bent over, and then a plate is separated from the plastic web along a cutting line, which is approximately perpendicular to the conveying direction.
